(19) United States
(12) Patent Application Publication
(10) Pub. No.: US 2026/0190003 A1
(43) Pub. Date: Jul. 2, 2026

(54) MAKE-BEFORE-BREAK MECHANISMS FOR SEAMLESS NETWORK TRAFFIC HANDOFF

(71) Applicant: MaxLinear, Inc., Carlsbad, CA (US)

(72) Inventors: Curtis Ling, Carlsbad, CA (US); Masoud Koochakzadeh, Carlsbad, CA (US); Sheng Ye, Carlsbad, CA (US); John Andrew Guckenberger, Carlsbad, CA (US); Sridhar Ramesh, Carlsbad, CA (US)

(73) Assignee: MaxLinear, Inc., Carlsbad, CA (US)

(21) Appl. No.: 19/435,422

(22) Filed: Dec. 29, 2025

Related U.S. Application Data
(60) Provisional application No. 63/739,466, filed on Dec. 27, 2024.

(51) Int. Cl. H04W 36/18

(52) U.S. Cl. CPC H04W 36/185

(57) ABSTRACT

Systems and methods for seamless network communication reconfiguration, comprising a device that includes physical media dependent (PMD) devices, incorporating a digital signal processor (DSP) configured to handle both in-band and out-of-band communication traffic, a plurality of primary analog crossbars connected to the DSPs for routing operational data, and a set of redundant analog crossbars configured to establish auxiliary communication channels. The system includes a controller operable to dynamically activate the auxiliary communication channels during reconfiguration events, enabling a make-before-break protocol by transitioning traffic from primary channels to auxiliary channels. The redundant crossbars support out-of-band signaling to coordinate transitions and maintain system integrity. The auxiliary channels remain in a low-power state during steady operation, ensuring resource efficiency, while the controller monitors signal integrity and initiates reconfiguration upon detecting a fault or network event, maintaining uninterrupted traffic flow.

### RELATED APPLICATION

This application claims the benefit of U.S. Provisional Application No. 63/739,466, filed Dec. 27, 2024, the disclosure of which is incorporated herein by reference in its entirety.

The examples discussed in the present disclosure are related to make-before-break mechanisms for seamless network traffic handoff.

### BACKGROUND

Unless otherwise indicated herein, the materials described herein are not prior art to the claims in the present application and are not admitted to be prior art by inclusion in this section.

Datacenters and artificial intelligence (AI) clusters often rely on packet-switched Ethernet switches for data transmission. However, Ethernet switches can introduce challenges such as unreliable delivery, variable performance, and high latency, which can negatively impact the demanding workloads in modern high-performance computing environments

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

The examples herein include a circuit-switched approach to data transmission via a fabric switch protocol that enables dedicated communication paths with predictable latency and increased reliability. The examples herein implement a so-called “make-before-break” (MBB) protocol within networked architectures that further enhances capabilities by ensuring seamless transitions between connections, for example, during reconfiguration or failover scenarios. In some examples, MBB protocols enable the establishment of new communication paths before existing connections are broken, thereby maintaining signal integrity and uninterrupted data flow. Such approach minimizes latency and prevents data loss, making the examples herein advantageous for maintaining high reliability and performance in mission-critical systems.

### BRIEF DESCRIPTION OF THE DRAWINGS

So that the manner in which the above recited features of the present disclosure can be understood in detail, a more particular description of the disclosure, briefly summarized above, may be had by reference to examples, some of which are illustrated in the appended drawings. It is noted, however, that the appended drawings illustrate only some aspects of this disclosure and the disclosure may admit to other equally effective examples.

To facilitate understanding, identical reference numerals have been used, where possible, to designate identical elements that are common to the figures. It is contemplated that elements and features of one example may be beneficially incorporated in other examples without further recitation.

FIG. 1 illustrates a schematic of an exemplary switch system;

FIG. 2 illustrates a flow diagram corresponding to an exemplary switch system;

FIG. 3A illustrates an example of make-before break for an exemplary switch system;

FIG. 3B illustrates an example of a receiver for an exemplary switch system;

FIG. 4A illustrates an example of redundancy for an exemplary switch system;

FIG. 4B illustrates an example of redundancy for an exemplary switch system;

FIG. 4C illustrates an example of a crossbar for an exemplary switch system;

FIG. 5 illustrates a flow diagram corresponding to an exemplary switch system;

FIG. 6 illustrates an example communication system;

FIG. 7 illustrates a schematic of an exemplary switch system;

FIG. 8A illustrates an example block diagram of a data center;

FIG. 8B illustrates an example switch device;

FIG. 8C illustrates an example switch device; and

FIG. 8D illustrates an example switch device.

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single example, but other examples are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” means that any difference is negligible, or that such differences are within an operating tolerance that are known to persons of ordinary skill in the art and provide for the desired performance and outcomes as described in one or more examples herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Examples described as being implemented in hardware should not be limited thereto, but can include examples implemented in software, or combinations of software and hardware, and vice-versa, as will be apparent to those skilled in the art, unless otherwise specified herein. In the examples described herein, an example showing a singular component should not be considered limiting; rather, the invention is intended to encompass other examples including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The examples described herein present a highly efficient and integrated solution that may be applied, for example, to network switches by expanding the role of Digital Signal Processors (DSPs) with “Make-Before-Break” (MBB) protocol. MBB protocol ensures that new communication paths are established and operational before existing connections are disrupted, eliminating data flow interruptions. In some examples, MBB protocol may leverage auxiliary communication lanes, redundant paths, and intelligent switching mechanisms to provide uninterrupted traffic, enhanced reliability, and optimized resource utilization. Accordingly, the examples describe below implement a fabric switch architecture presented as an alternative to Ethernet switches by providing a circuit-switched approach to data transmission. Unlike packet-switched Ethernet networks, the fabric switch protocol of the examples herein enables dedicated communication paths with predictable latency and increased reliability. Such characteristics make the fabric switch protocols described below particularly well-suited for applications requiring high performance, throughput, and minimal latency, such as those in datacenters and AI clusters.

In some examples, the implementation of MBB in advanced architectures, such as analog crossbars and DSPs, further enhances system performance. By integrating auxiliary in-band transceivers and out-of-band signaling capabilities, these architectures support dynamic reconfiguration, fault tolerance, and energy-efficient operations. MBB protocols are particularly advantageous in applications requiring high-speed, low-latency, and fail-safe communication, such as telecommunications networks, data centers, and AI-driven systems

Thus, by incorporating MBB protocols, fabric switches can dynamically reconfigure connections without disrupting ongoing communication, supporting the scalability and adaptability used in modern datacenter and AI environments. Such capability is especially advantageous for high-speed data transfers, redundancy management, and failover scenarios, where maintaining uninterrupted operations is desired, which is descried in detail below.

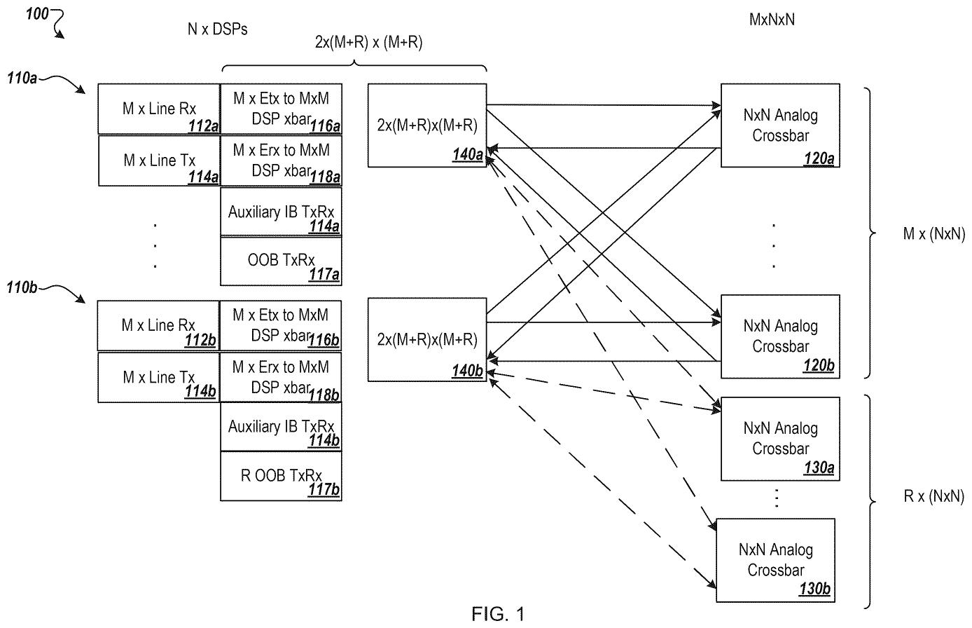

Referring now to FIG. 1, FIG. 1 depicts device 100, which is operable for implementing MBB protocols for seamless network traffic and reconfiguration. As shown in FIG. 1, in some examples, device 100 may include one or more PMDs. PMDs may include DSPs 110a, 110b. In some examples, device 100 may include analog crossbars 120a, 120b that may be in communication with DSPs 110a, 110b. In some examples, device 100 may include one or more sets of redundant analog crossbars 130a, 130b. Analog crossbars 130a, 130b may connect to DSPs 110a, 110b. The set of redundant analog crossbars 130a, 130b may provide one or more of additional input lanes or additional output lanes, which is described in further detail below.

In some examples, physical media dependent (PMD) devices which may include DSPs 110a, 110b may have various functionality. On the line side, DSP 110a may receive line traffic using M×Line Rx 112a and transmit line traffic using M×Line Tx 114a. On the switch side, DSP 110a may transmit switch traffic using M×ETX to M×M DSP xbar 116a and may receive switch traffic using M×ERx to M×M DSP xbar 118a.

Similarly, on the line side, DSP 110b may receive line traffic using M×Line Rx 112b and may transmit line traffic using M×Line Tx 114b. On the switch side, DSP 110b may transmit switch traffic using M×ETx to M×M DSP xbar 116b and receive switch traffic using M×ERx to M×M DSP xbar 118b. Although two DSPs 110a and 110b are illustrated, there may be N DSPs in which N may be any integer greater than or equal to 1 (e.g., 2, 3, 4, or more).

In some examples, the DSP 110a, 110b may have M×M DSP crossbar functionality in which ‘M’ refers to the number of lanes. The M×M DSP crossbar functionality may be modified to include a different number of lanes. In one example, the number of lanes for DSP 110a, 110b may be based on the crossbar dimensions M×(M+R) in which R refers to a number of redundant lanes. In another example, the number of lanes for DSP 110a, 110b may be based on the crossbar dimensions 2×M×(M+R) in which the Tx traffic uses crossbar dimensions having M×(M+R) and the Rx traffic uses crossbar dimensions having M×(M+R). The crossbar functionality for DSP 110a, 110b may be repeated in N iterations in which N refers to the number of DSPs 110a, 110b and/or PMDs.

In some examples, DSP's 110a, 110b radix may be increased by increasing the number of analog crossbars (e.g., M to M+R). DSP crossbar 140a, 140b may be coupled to M analog crossbars 120a, 120b and to R redundant analog crossbars 130a, 130b. For example, DSP crossbar 140a may be coupled to N×N analog crossbar 120a, N×N analog crossbar 120b, N×N redundant analog crossbar 130a, and N×N redundant analog crossbar 130b. Similarly, DSP crossbar 140b may be coupled to N×N analog crossbar 120a, N×N analog crossbar 120b, N×N redundant analog crossbar 130a, and N×N redundant analog crossbar 130b. There may be a total of M analog crossbars and a total of R redundant analog crossbars in which M is any integer (e.g., 2) greater than or equal to 1 and R is any integer (e.g., 2) greater than or equal to 1.

In some examples, the in-band (IB) switch traffic from DSP crossbars 140a, 140b may be directed to the N×N analog crossbars 120a, 120b. In addition, the IB switch traffic from the output of the M analog crossbars 120a, 120b may be directed to DSP crossbars 140a, 140b.

The redundant analog crossbars 130a, 130b may be used for one or more of in-band traffic or out-of-band traffic. For example, the redundant paths between DSP crossbars 140a, 140b and the redundant analog crossbars 130a, 130b may be used for IB traffic. For example, DSP crossbar 140a may direct IB traffic to redundant analog crossbars 130a, 130b, and redundant analog crossbars 130a, 130b may direct IB-traffic to DSP crossbars 140a. Similarly, DSP crossbar 140b may direct IB traffic to redundant analog crossbars 130a, 130b, and redundant analog crossbars 130a, 130b may direct IB traffic to DSP crossbars 140b.

The R alternative paths may be used to connect any input to any output. The R alternative paths may allow the resolution of up to R failures per analog crossbar integrated circuit (IC) (including input/output (I/O) buffer and switch failures). The R alternative paths may also provide for hitless switch reconfiguration by allowing two inputs to disturb exactly two outputs.

The device 100 may further include non-volatile memory that may store and recover a crossbar state after power loss. Storing a crossbar state may allow the state to be recovered faster after a power loss.

In some examples, device 100 may include out-of-band (OOB) signaling. OOB signaling utilizes redundant analog crossbars 130a, 130b for providing redundancy for IB traffic, and providing for OOB traffic. For example, when R is equal to 2, one of the redundant analog crossbars 130a may be used for OOB traffic to DSP 110a, 110b and the other redundant analog crossbar 130b may be used for IB traffic to DSP 110a, 110b.

In some examples, DSP 110a, 110b may have R OOB transceivers (TxRx) 117a, 117b to connect to the R redundant analog crossbars 130a, 130b. For example, the OOB TxRx 117a, 117b may be 10 G serial deserializer (SERDES), a serial peripheral interface, or the like.

The redundant analog crossbars 130a, 130b may be used for various functions. For example, the redundant analog crossbars 130a, 130b may communicate to one or more DSPs 110a, 110b without blocking IB traffic. In some examples, a switch controller (SC) (not shown) may broadcast OOB to DSPs 110a, 110b and the analog crossbar ICs 120a, 120b and the redundant analog crossbars 130a, 130b. The SC may use OOB to communicate with individual DSPs 110a, 110b and/or analog crossbar ICs 120a, 120b and/or the redundant analog crossbars 130a, 130b. In some examples, time division multiplexing or broadcast may be used to address a subset of DSPs 110a, 110b and/or analog crossbar ICs 120a, 120b and/or redundant analog crossbars 130a, 130b. The SC may communicate control signals to the individual DSPs 110a, 110b and/or analog crossbar ICs 120a, 120b and/or the redundant analog crossbars 130a, 130b.

In some examples, analog crossbars 120a, 120b and the redundant analog crossbars 130a, 130b may include OOB Tx/Rx which may be used to be individually addressable. In some examples, time division multiplexing may be used to communicate to or from analog crossbars 120a, 120b and redundant analog crossbars 130a, 130b.

In some examples, one or more auxiliary in-band transceivers (aux IB Tx/Rx) 119a, 119b may be included in DSPs 110a, 110b. The aux IB channel may be the same as the other IB channels. The aux IB Tx/Rx 119a, 119b may use the redundant analog crossbars 130a, 130b to communicate with other devices. The aux IB Tx/Rx 119a, 119b may be used to communicate or combine IB traffic, e.g., from one or more of the DSPs IB lanes. The analog crossbars 120a, 120b may receive IB switch traffic. The analog crossbars 120a, 120b may communicate IB switch traffic from an output.

One or more of DSPs 110a, 110b or the analog crossbars 120a, 120b may include one or more redundant input lanes or one or more redundant output lanes to facilitate failover. As illustrated in FIG. 1, redundancy may be used for make-before-break (MBB) handoff. The aux IB Tx/Rx 119a, 119b may be used for MBB lane switching and may be placed in low power mode during steady state to save power.

In one example, one or more redundant lanes may be used for OOB signaling. OOB signaling may be implemented using OOB Tx/Rx within the DSPs or using the switch controller. The switch controller may use one or more of the redundant lanes to connect to DSPs 110a, 110b. The OOB transceiver may be at a lower rate than the IB Tx/Rx, which may use e.g., inter integrated circuit (I2C), serial peripheral interface (SPI), 10 G SERDES, or the like. OOB signaling may be broadcast from a DSP 110a, 110b and/or switch controller to the other DSPs 110a, 110b. Using one or more redundant lanes may implement hitless switching. The switch controller may route in-band traffic through one or more of the redundant lanes.

Out-of-band communication paths may be used to activate the set of redundant crossbars 130a, 130b during failover. For example, OOB communication paths may communicate using OOB Tx/Rx within the DSPs or using the switch controller.

One or more of the redundant lanes may be used for MBB connectivity. For example, one or more of the redundant lanes may be on the switch side of the DSP (e.g., 8 lanes on the line side and e.g., 9 lanes on the switch side to provide a redundant lane). When lane 8 on the switch side fails, then lane 9 may be switched to.

Traffic may be re-routed to the one or more additional input lanes or the one or more additional output lanes when failover occurs without a disruption or latency increase. DSPs 110a, 110b may include an auxiliary in-band transceiver 119a, 119b for establishing IB connections between DSPs 110a, 110b before handing off to primary transceivers. The auxiliary in-band transceiver 119a, 119b may permit fast reacquisition (lower/zero overhead) switching. The auxiliary in-band transceiver 119a, 119b may allow hitless switching, in which the switch may be reconfigured without interrupting traffic in the lanes, including the affected lanes.

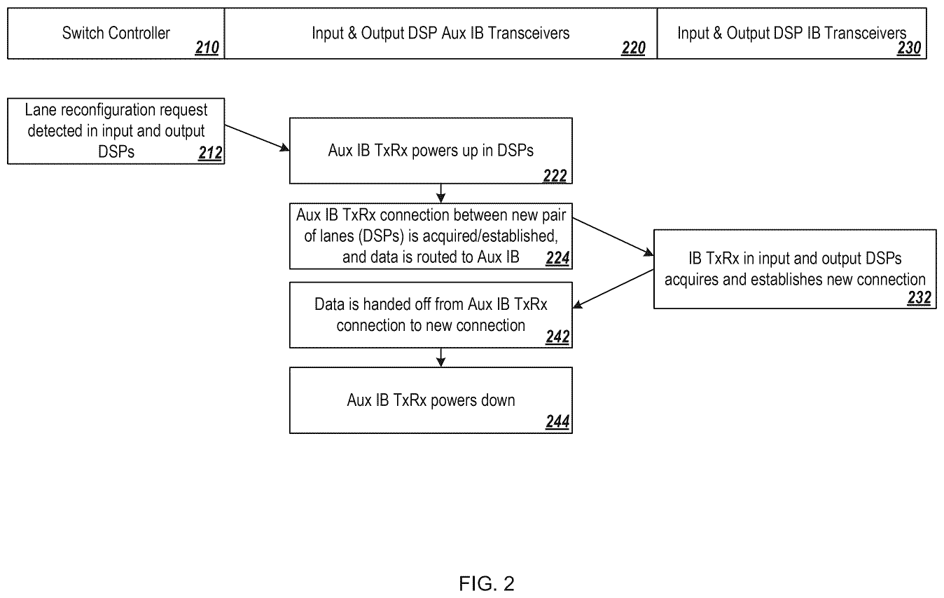

Referring now to FIG. 2 in conjunction with FIG. 1, FIG. 2 illustrates an example of MBB handoff, which may be implemented by device 100, in accordance with some examples. In some examples, an analog electrical circuit switch (AECS) controller 210 may detect a lane reconfiguration request in input and output DSPs, as shown in block 212. Controller 210 may be the same or similar to the DSP SC of device 100. In some examples, input and output DSP aux IB transceivers 220 may be powered up in the DSPs, as shown in block 222. The aux IB Tx/Rx connection between new pair of lanes in the DSPs may be acquired and/or established and data may be routed to the auxiliary IB, as shown in block 224. At the input and output DSP IB transceiver 230, the IB Tx/Rx in input and output DSPs may be acquired and may establish a new connection, as shown in block 232. At the input and output DSP aux IB transceivers 220, data may be handed off from the aux IB Tx/Rx connection to a new connection, as shown in block 242. At block 244, the aux IB Tx/Rx may power down.

In addition or alternatively, the aux IB channel may be used to communicate with nearest neighbors. For example, a separate wire may be used to connect to nearest neighbor aux IB lanes. The nearest neighbors may have clean channels between them which may allow for simplified PHY processing for significant power and latency reduction, less equalization, and the like.

In some examples, MBB protocol leverages redundancy mechanisms to ensure seamless transitions during reconfiguration or failover events. Each DSP 110a, 110b may utilize redundant analog crossbars 130a, 130b to maintain active communication pathways during a switchover. Redundant paths provide fail-safe measures, allowing the MBB protocol to reroute traffic dynamically without disrupting active data flows. For instance, when a primary lane experiences degradation or failure, the redundant crossbars are immediately engaged to support uninterrupted data transmission. The controller dynamically manages these transitions, ensuring that signal integrity and traffic continuity are maintained throughout the process.

For example, in scenarios involving multiple failures, the MBB protocol scales efficiently by utilizing the R alternative paths to address up to R simultaneous failures per crossbar. These paths are designed to resolve input/output (I/O) buffer failures and switch circuit anomalies, ensuring that no single point of failure compromises the system's reliability.

In some examples, auxiliary in-band (IB) channels, such as aux IB Tx/Rx 119a, 119b, are integral to the MBB protocol. These channels remain in a low-power state during steady operations, conserving energy and minimizing the overall power footprint of the system. Upon detecting a reconfiguration request, the auxiliary channels are powered up to establish temporary connectivity. Such approach ensures that energy consumption remains efficient, with auxiliary resources only activated during operations, such as lane handoffs or fault recovery. Once the primary pathways are reestablished, the auxiliary channels are powered down. The cycle of selective activation and deactivation optimizes power usage while supporting high-speed, low-latency transitions.

In some examples, calibration between auxiliary and primary lanes is an advantageous aspect of the MBB protocol. The controller ensures that all auxiliary and redundant paths are pre-calibrated to match the operating parameters of the primary channels. Pre-calibration includes maintaining clock alignment, equalization settings, and jitter minimization to enable seamless traffic handoff. Such calibration processes allow the auxiliary lanes to take over data transmission instantaneously, without introducing latency or compromising data integrity.

Dynamic synchronization mechanisms ensure that auxiliary lanes are always, or almost always, ready to handle traffic seamlessly, with real-time adjustments made to account for changes in traffic patterns, environmental conditions, or signal quality.

In some examples, redundant crossbars 130a, 130b and associated OOB transceivers (e.g., TxRx 117a, 117b) provide additional capabilities for MBB operations. OOB signaling is used to manage system-level operations, including lane activation, diagnostic monitoring, and failover coordination. The switch controller utilizes OOB paths to communicate with DSPs, crossbars, and other system components, ensuring that the reconfiguration process remains under precise control.

In some examples, OOB signaling paths are also leveraged for auxiliary tasks, such as broadcasting system updates, monitoring traffic conditions, and initiating calibration cycles. By separating OOB and IB traffic, the system maintains higher throughput for data lanes while ensuring robust control over reconfiguration events.

In some examples, MBB protocols can operate in conjunction with Time Division Multiplexing (TDM) to further enhance efficiency. For example, redundant paths and auxiliary channels can be allocated dynamically within TDM cycles, ensuring that bandwidth resources are optimally utilized. The switch controller manages these allocations in real-time, adapting to traffic demands and system conditions. For example, in TDM configurations, the auxiliary IB Tx/Rx 119a, 119b and OOB TxRx 117a, 117b facilitate precise control over switching intervals, enabling smooth transitions without overlapping or interfering with active traffic.

The MBB protocol is designed to scale with system complexity. As the number of DSPs and crossbars increases, the controller dynamically adjusts the allocation of auxiliary lanes and redundant paths. Modular redundancy allows for incremental expansion, with additional crossbars or DSPs integrated seamlessly into the existing architecture.

The use of N×N crossbars ensures that all components can interconnect efficiently, regardless of the system size. Such scalability makes MBB protocols ideal for large-scale applications such as data centers, telecommunications networks, and AI clusters.

The MBB protocol minimizes failover latency through preemptive lane activation and real-time traffic monitoring. By establishing auxiliary connections before breaking existing ones, the system ensures that traffic redirection occurs instantaneously.

Latency metrics are further improved through hardware-optimized controllers and high-speed transceivers, which reduce the time for lane acquisition and calibration. This is particularly advantageous in high-performance computing environments, where even microsecond delays can impact system efficiency.

Outside of device 100, in some examples, MBB protocols are advantageous for ensuring uninterrupted operation in safety-critical systems, such as Internet of Things (IoT) networks. MBB provides a robust framework for maintaining reliability in large-scale deployments. For example, in smart cities, IoT devices such as traffic cameras, environmental sensors, and utility meters rely on uninterrupted communication to function effectively. MBB ensures that reconfiguration events, such as traffic redirection or server updates, do not disrupt real-time data transmission, supporting applications like traffic management and environmental monitoring

In some examples, Industrial IoT (IIoT) environments also benefit significantly from MBB protocols. During equipment reconfiguration or system updates, MBB maintains uninterrupted communication between factory floor equipment and centralized monitoring systems. This ensures continuous production line operations, minimizing downtime and maximizing efficiency in industries where even short delays can result in substantial operational losses.

Across these diverse applications, MBB protocols demonstrate their versatility in ensuring reliability, reducing latency, and maintaining system integrity during dynamic reconfigurations. Whether in safety-critical environments (such as autonomous vehicles, avionics, industrial automation, or aerospace networks) or large-scale interconnected networks, MBB provides the framework for seamless communication and operational continuity.

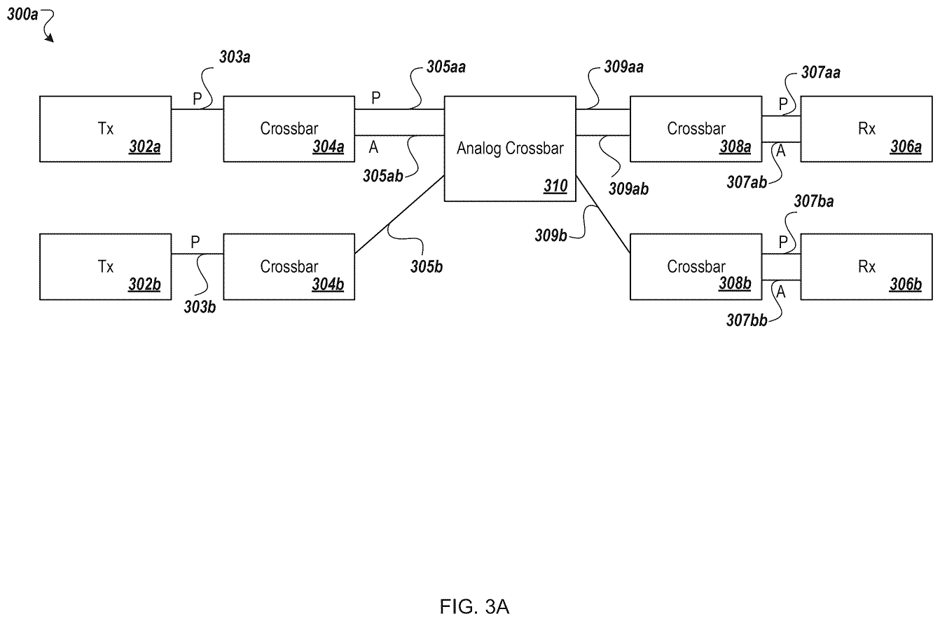

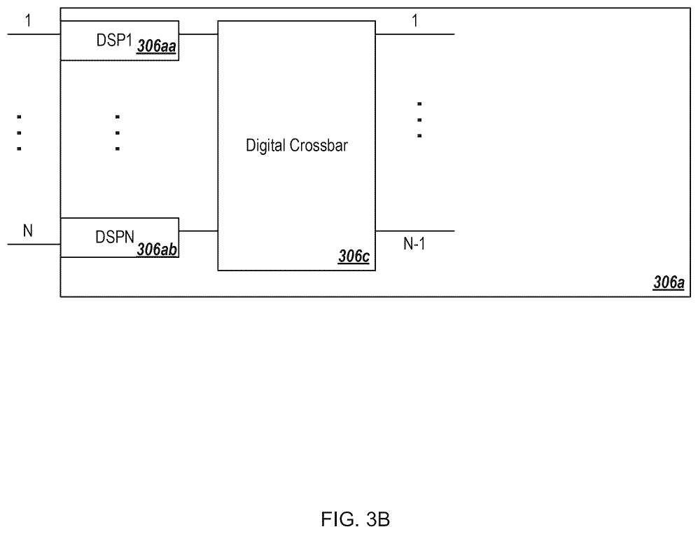

FIG. 3A illustrates an example of make-before break for an exemplary switch system 300a. The switch system 300a may include Tx 302a, Tx 302b, Rx 306a, Rx 306b. Tx 302a may be coupled to a crossbar 304a using a primary lane 303a and/or one or more additional lanes. Tx 302b may be coupled to crossbar 304b using a primary lane 303b and/or one or more additional lanes. Crossbar 304a may be coupled to analog crossbar 310 using a primary lane 305aa, an auxiliary lane 305ab, and/or one or more additional lanes. Crossbar 304b may be coupled to analog crossbar 310 using lane 305b, and/or one or more additional lanes. Rx 306a may be coupled to crossbar 308a using a primary lane 307aa, an auxiliary lane 307ab, and/or one or more additional lanes. Rx 306b may be coupled to crossbar 308b using a primary lane 307ba, an auxiliary lane 307bb, and/or one or more additional lanes. Crossbar 308a may be coupled to analog crossbar 310 using lane 309aa, lane 309ab, and/or one or more additional lanes. Crossbar 308b may be coupled to analog crossbar 310 using lane 309b and/or one or more additional lanes.

The make-before break process may include several operations. In a first operation, Rx 306a may receive data on primary lane 307aa via crossbar 308a, lane 309aa, analog crossbar 310, lane 305b, crossbar 304b, and primary lane 303b from Tx 302b. Alternatively or in addition, Rx 306b may receive data on primary lane 307ba via crossbar 308b, lane 309b, analog crossbar 310, primary lane 305aa, crossbar 304a, and primary lane 303a from Tx 302a. While Rx 306a receives from Tx 302b and/or Rx 306b receives from Tx 302a, in a second operation, Tx 302a may multicast via primary lane 303a and crossbar 304a to primary lane 305aa and auxiliary lane 305ab with auxiliary lane 305ab coupled to 306a via analog crossbar 310, lane 309ab, crossbar 308a, and auxiliary lane 307ab. Thus, the signal may be replicated at 305aa and 305ab. Because of the multicasting, Tx 302a may not have an auxiliary lane because the signal is replicated. In addition, multicasting allows the data flow between Tx 302b to Rx 306a to continue without interruption. In a third operation, Rx 306a may receive on auxiliary lane 307ab from Tx 302a which may use some settling time due to crossbar reconfiguration time. As a result, in a fourth operation, auxiliary lane 307ab for Rx 306a may become the primary lane as the digital crossbar in Rx 306a reconfigures. Therefore, as a result of the operations, a data flow from Tx 302b to Rx 306a may transition to a data flow from Tx 302a to Rx 306a in a seamless process while data flows continue between Tx 302a to Rx 306b and between Tx 302b to Rx 306a.

FIG. 3B illustrates an example of an Rx 306a of an exemplary switch system. For example Rx 306a may include N DSPs (e.g., DSP 1 306aa to DSP N 306ab) that may be coupled to N lanes. The N DSPs may be coupled to a digital crossbar 306c using N inputs. The digital crossbar 306c may have N−1 outputs.

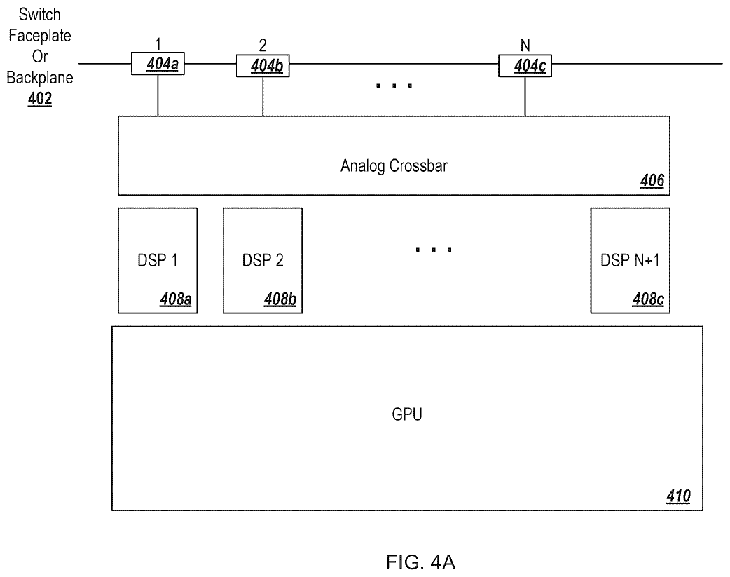

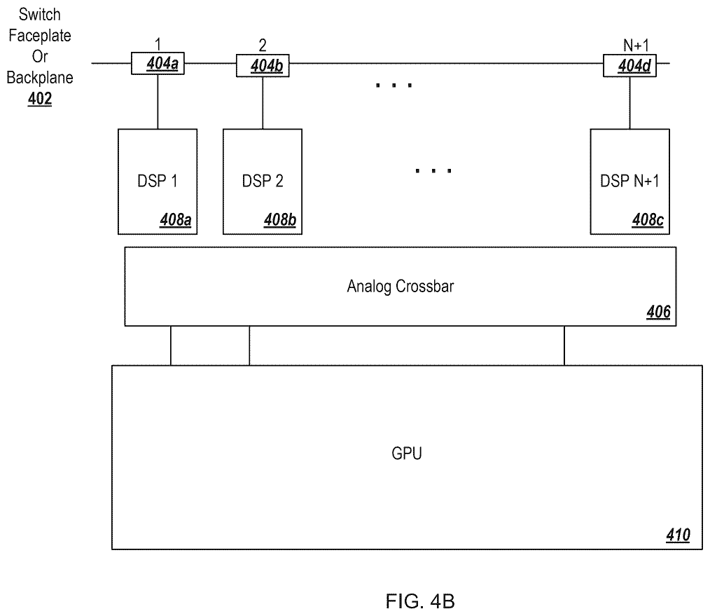

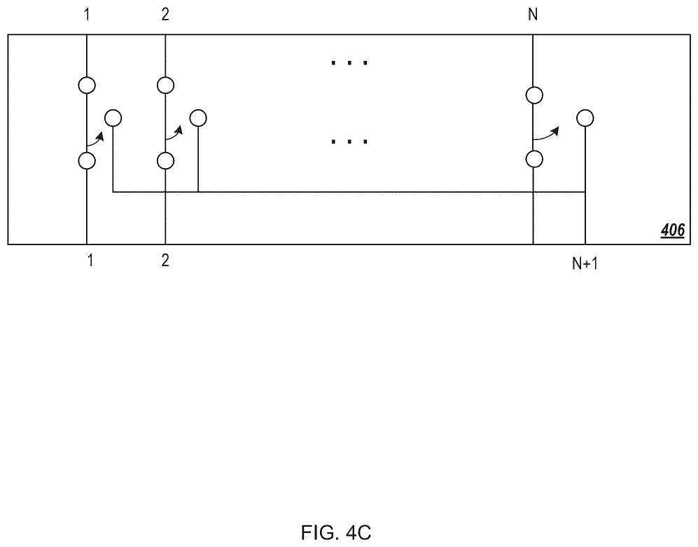

FIG. 4A illustrates an example of redundancy for an exemplary switch system. A switch faceplate 402 or backplane may have N connections (e.g., connection 404a, connection 404b, connection 404c) to an analog crossbar 406. The analog crossbar 406 may receive N+1 inputs (e.g., from N+1 DSPs such as DSP 1 408a, DSP 2 408b, DSP N+1 408c). The N+1 DSPs may drive copper backplane lanes. The N+1 DSPs may be coupled to e.g., a GPU 410 or a chiplet. Having N+1 DSPs available may provide redundancy because DSP N+1 408c may be on standby in the case that one of the other DSPs fails. DSP N+1 408c may connect to any of the N outputs via analog crossbar 406 using the N+1 input on the analog crossbar 406.

FIG. 4B illustrates an example of redundancy for an exemplary switch system. A switch faceplate 402 or backplane may have N+1 connections (e.g., connection 404a, connection 404b, connection 404d). The N+1 connections may be coupled to N+1 DSPs (e.g., DSP 1 408a, DSP2 408b, DSP N+1 408c). The DSPs may be co-packaged optics (CPOs) that may drive one or more of photonics or copper backplane lanes. The DSPs may be coupled to an analog crossbar 406 which may be coupled to a GPU, a chiplet, or the like. The DSPs may be coupled to the analog crossbar 406 using fast-narrow interfaces (e.g., ultra accelerator link (UALink)) and/or slow-wide interfaces (e.g., universal chiplet interconnect express (UCIe)).

FIG. 4C illustrates an example of an analog crossbar 406 for an exemplary switch system. The analog crossbar 406 may include N+1 inputs and N outputs. An output of the N outputs may be switchable to connect to a corresponding input (i.e., output 1 may connect to input 1) or to an N+1 input (i.e., output 1 may connect to input N+1). Thus, the N outputs may be switchable to connect to the N+1 input. As a result, redundancy may be provided for the case that an input fails. For example, if input 2 failed, output 2 may switch to be connected to the N+1 input.

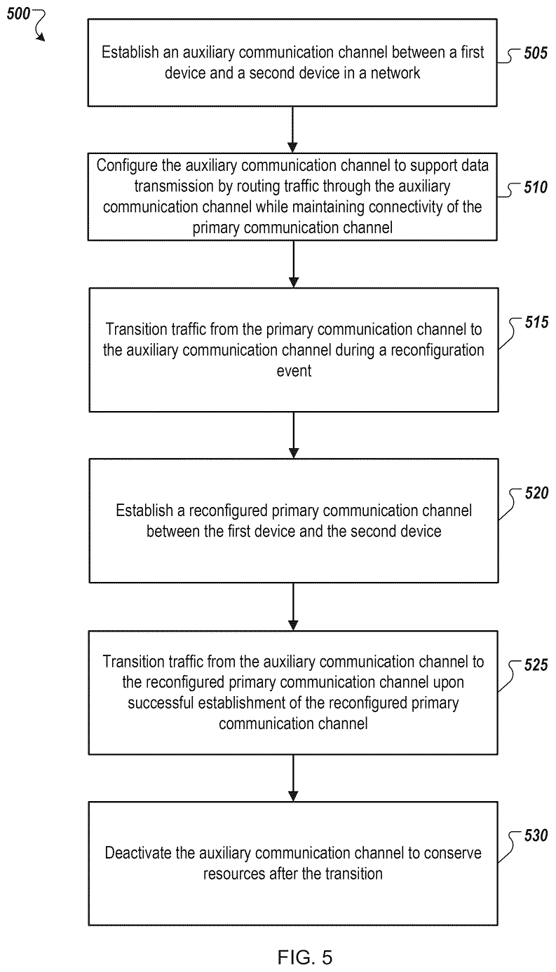

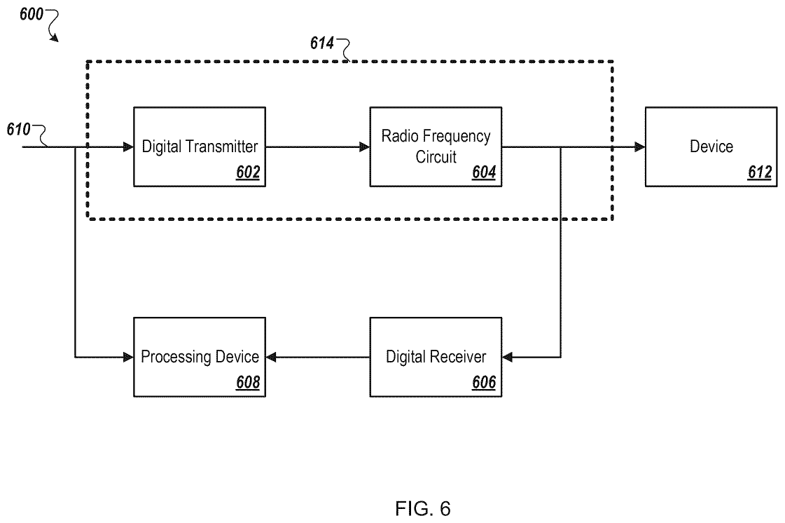

Referring now to FIG. 5, in conjunction with FIGS. 1-2, FIG. 5 illustrates a process flow of an example method 500 corresponding to MBB protocols in a networked system, ensuring uninterrupted communication during channel reconfiguration, in accordance with some examples. Method 500 may be performed by processing logic that may include hardware (circuitry, dedicated logic, etc.), software (such as is run on a computer system or a dedicated machine), or a combination of both, which processing logic may be included in the processing device 100 of FIG. 1, the communication system 600 of FIG. 6, or another device (e.g. IOT devices, AI clusters, data centers, and the like), combination of devices, or systems.

In some examples at block 505, the controller establishes an auxiliary communication channel between a first device and a second device in the network. This auxiliary channel is distinct from the primary communication channel, which is used for transmitting operational data. For example, in the context of device 100, this involves the activation of redundant analog crossbars (e.g., 130a, 130b) connected to DSPs 110a, 110b to create a dedicated path for auxiliary traffic. This step ensures that the auxiliary channel is operational and ready to support data traffic without interfering with ongoing operations in the primary channel. FIG. 2 further illustrates how the auxiliary transceivers (aux IB Tx/Rx) in DSPs may communicate through these redundant paths, leveraging both in-band and out-of-band signaling.

At block 510, the auxiliary communication channel is configured to support data transmission by routing traffic through it while maintaining the connectivity of the primary communication channel. This ensures that the auxiliary channel is not just established but actively operational for handling data. In FIG. 1, this functionality is represented by the ability of the auxiliary transceivers (e.g., 119a, 119b) to communicate over redundant analog crossbars without disrupting in-band traffic handled by primary crossbars (120a, 120b). The controller may utilize out-of-band signaling paths for seamless channel setup, as described previously, ensuring redundancy and minimal latency during this phase.

At block 515, the controller transitions traffic from the primary communication channel to the auxiliary communication channel during a reconfiguration event. This reconfiguration event could be triggered by a failure in the primary channel, the need for load balancing, or planned maintenance. For example, in FIG. 1, if a failure is detected in the primary path through DSP crossbars 140a or 140b, traffic can be dynamically rerouted to the auxiliary path established via redundant crossbars. The aux IB transceivers (119a, 119b) facilitate this handoff with minimal latency, ensuring that operational traffic remains unaffected.

At block 520, the controller establishes a reconfigured primary communication channel between the first and second devices. This involves re-establishing the original primary path or creating a new primary path using available resources. Referring back to FIG. 1, the primary crossbars (120a, 120b) are reactivated or reconfigured to handle traffic once the fault or maintenance event is resolved. The controller ensures that the reconfigured channel meets the signal integrity and traffic conditions.

At block 525, traffic is transitioned back from the auxiliary communication channel to the reconfigured primary communication channel upon successful establishment of the reconfigured primary channel. The auxiliary channel's role as a temporary traffic route ends, and traffic flow resumes over the main operational path. This step ensures a smooth handoff back to the primary channel, as depicted in FIG. 2, where traffic initially handled by the aux IB transceivers is redirected to the main transceivers in the DSPs.

At block 530, the auxiliary communication channel is deactivated to conserve resources after the transition. This includes powering down the auxiliary transceivers and redundant crossbars that were activated during the reconfiguration process. This step, as represented in FIGS. 1 and 2, ensures that the auxiliary path is not consuming unnecessary power, maintaining system efficiency. By placing the auxiliary path in a low-power state, the system achieves resource optimization without compromising readiness for future reconfigurations.

Thus, method 500 encapsulates the robust mechanisms described in FIGS. 1 and 2, emphasizing the role of MBB in maintaining seamless network operations. The use of auxiliary and redundant components, in conjunction with dynamic traffic management by the controller, ensures uninterrupted communication across diverse applications, from data centers to IoT networks.

Modifications, additions, or omissions may be made to the method 500 without departing from the scope of the present disclosure. For example, in some examples, the method 500 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 6 illustrates a block diagram of an example communication system 600, in accordance with at least one example described in the present disclosure. The communication system 600 may include a digital transmitter 602, a radio frequency circuit 604, a device 612, a digital receiver 606, and a processing device 608. The digital transmitter 602 and the processing device may be configured to receive a baseband signal via connection 610. A transceiver 614 may comprise the digital transmitter 602 and the radio frequency circuit 604.

In some examples, the communication system 600 may include a system of devices that may be configured to communicate with one another via a wired or wireline connection. For example, a wired connection in the communication system 600 may include one or more Ethernet cables, one or more fiber-optic cables, and/or other similar wired communication mediums. Alternatively, or additionally, the communication system 600 may include a system of devices that may be configured to communicate via one or more wireless connections. For example, the communication system 600 may include one or more devices configured to transmit and/or receive radio waves, microwaves, ultrasonic waves, optical waves, electromagnetic induction, and/or similar wireless communications. Alternatively, or additionally, the communication system 600 may include combinations of wireless and/or wired connections. In some examples, the communication system 600 may include one or more devices that may be configured to obtain a baseband signal, perform one or more operations to the baseband signal to generate a modified baseband signal, and transmit the modified baseband signal, such as to one or more loads.

In some examples, the communication system 600 may include one or more communication channels that may communicatively couple systems and/or devices included in the communication system 600. For example, the transceiver 614 may be communicatively coupled to the device 612.

In some examples, the transceiver 614 may be configured to obtain a baseband signal. For example, as described herein, the transceiver 614 may be configured to generate a baseband signal and/or receive a baseband signal from another device. In some examples, the transceiver 614 may be configured to transmit the baseband signal. For example, upon obtaining the baseband signal, the transceiver 614 may be configured to transmit the baseband signal to a separate device, such as the device 612. Alternatively, or additionally, the transceiver 614 may be configured to modify, condition, and/or transform the baseband signal in advance of transmitting the baseband signal. For example, the transceiver 614 may include a quadrature up-converter and/or a digital to analog converter (DAC) that may be configured to modify the baseband signal. Alternatively, or additionally, the transceiver 614 may include a direct radio frequency (RF) sampling converter that may be configured to modify the baseband signal.

In some examples, the digital transmitter 602 may be configured to obtain a baseband signal via connection 610. In some examples, the digital transmitter 602 may be configured to up-convert the baseband signal. For example, the digital transmitter 602 may include a quadrature up-converter to apply to the baseband signal. In some examples, the digital transmitter 602 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 602.

In some examples, the transceiver 614 may include one or more subcomponents that may be used in preparing the baseband signal and/or transmitting the baseband signal. For example, the transceiver 614 may include an RF front end (e.g., in a wireless environment) which may include a power amplifier (PA), a digital transmitter (e.g., 602), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 604) of the transceiver 614 may be synchronized with the resource controller via the S-plane device, which may contribute to high-accuracy timing with respect to a reference clock.

In some examples, the transceiver 614 may be configured to obtain the baseband signal for transmission. For example, the transceiver 614 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 614 may be configured to generate a baseband signal for transmission. In some examples, the transceiver 614 may be configured to transmit the baseband signal to another device, such as the device 612.

In some examples, the device 612 may be configured to receive a transmission from the transceiver 614. For example, the transceiver 614 may be configured to transmit a baseband signal to the device 612.

In some examples, the radio frequency circuit 604 may be configured to transmit the digital signal received from the digital transmitter 602. In some examples, the radio frequency circuit 604 may be configured to transmit the digital signal to the device 612 and/or the digital receiver 606. In some examples, the digital receiver 606 may be configured to receive a digital signal from the RF circuit and/or send a digital signal to the processing device 608.

In some examples, the processing device 608 may be a standalone device or system, as illustrated. Alternatively, or additionally, the processing device 608 may be a component of another device and/or system. For example, in some examples, the processing device 608 may be included in the transceiver 614. In instances in which the processing device 608 is a standalone device or system, the processing device 608 may be configured to communicate with additional devices and/or systems remote from the processing device 608, such as the transceiver 614 and/or the device 612. For example, the processing device 608 may be configured to send and/or receive transmissions from the transceiver 614 and/or the device 612. In some examples, the processing device 608 may be combined with other elements of the communication system 600.

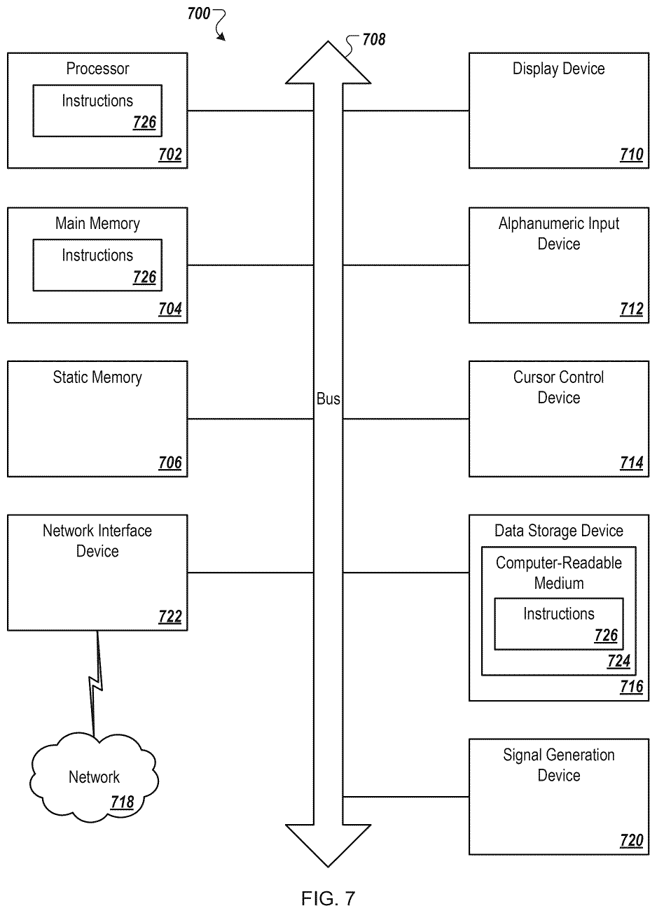

FIG. 7 illustrates a diagrammatic representation of a machine in the example form of a computing device 700 within which a set of instructions, for causing the machine to perform any one or more of the methods discussed herein, may be executed. The computing device 700 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 700 includes a processing device (e.g., a processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

Processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computing device 700 may further include a network interface device 722 which may communicate with a network 718. The computing device 700 also may include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one example, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 718 via the network interface device 722.

While the computer-readable storage medium 724 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

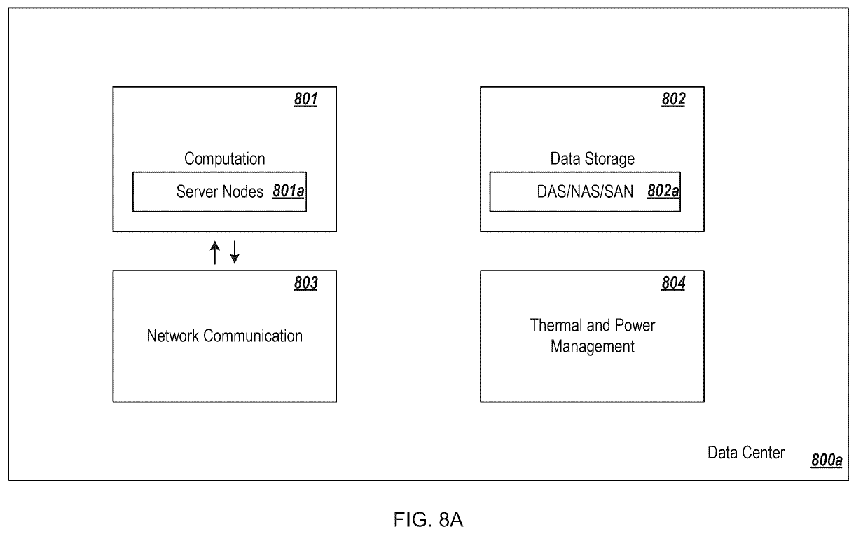

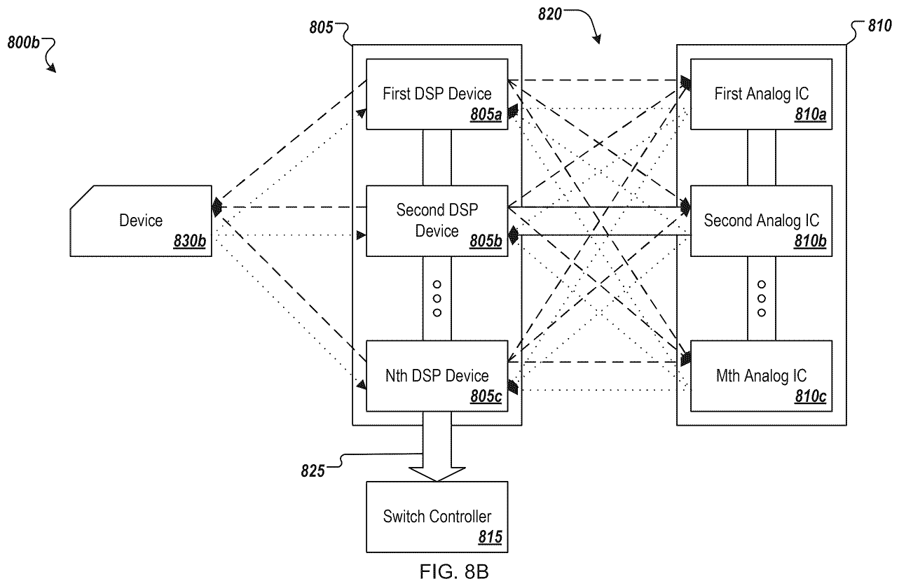

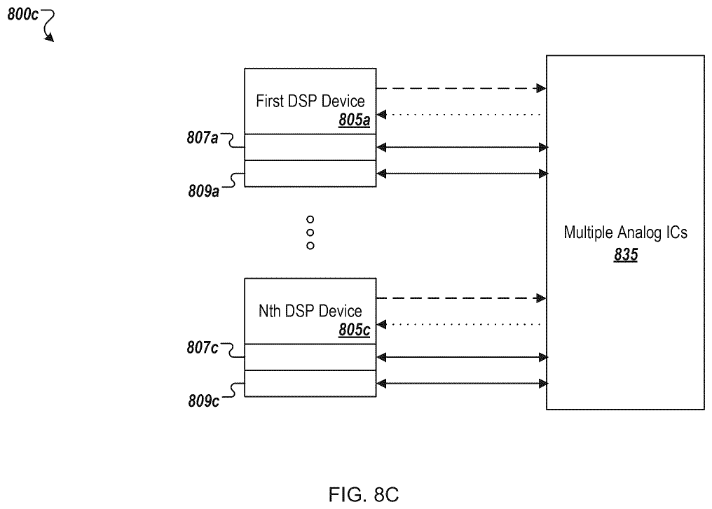

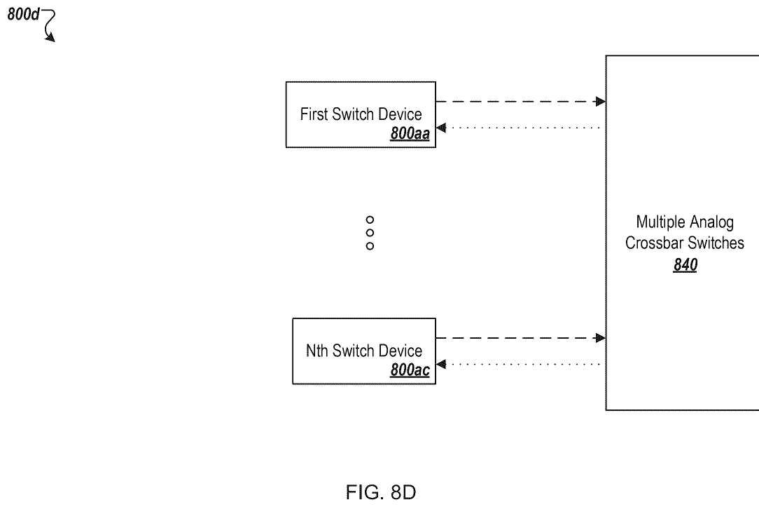

As illustrated in FIG. 8A, a block diagram of a data center 800a may include multiple subsystems configured to perform various operational functions, including computation 801, data storage 802, network communication 803, and thermal and power management 804. The computation 801 subsystem may include one or more server nodes 801a that may execute software applications and process data workloads. The data storage 802 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 802a. The networking communication 803 subsystem may facilitate bidirectional data transfer between servers and external networks through high-speed switching and routing components. The thermal and power management 804 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 800a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6 kW each, and 9 switch trays consuming about 1 kW each. Each GPU may have 18 ports of 100 GB/s each (or 1.8 TB/s per GPU), and the rack network (which may be implemented using a copper backplane) may connect each GPU to the 9 switch trays to provide each GPU with the ability to deliver all of its 1.8 TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch system on chips (SOCs) with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, ⅕ of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5 ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 8B illustrates an example switch device 800b. The switch device 800b may include a first digital signal processor (DSP) device 805a, a second DSP device 805b, an nth DSP device 805c, referred to collectively as multiple first electronic devices 805, a first analog integrated circuit (IC) 810a, a second analog IC 810b, an mth analog IC 810c, referred to collectively as multiple second electronic devices 810, a switch controller 815, in-band traffic 820, and out-of-band traffic 825. First DSP 805a, second DSP 805b, and nth DSP 805c may have input and output.

The switch device 800b may be reconfigurable (e.g., in terms of the connections between the components therein, such as the multiple first electronic devices 805 and the multiple second electronic devices 810, the switch controller 815, and/or a device 830), where the switching of the connections/lanes between the components may be low latency (e.g., less than 5 ns, 10 ns, or the like switching). Alternatively, or additionally, the switch device 800b may reconfigure without the use of retiming such that each lane of the multiple lanes included therein may use less than 50 mW of power. For example, each lane of the multiple lanes may support 100 G bandwidth while using less than 50 mW of power.

The multiple first electronic devices 805 may individually include one or more ports that may be used to facilitate communications within the switch device 800b, such as between the multiple first electronic devices 805 and the multiple second electronic devices 810, the switch controller 815, and/or a device 830. The communications in the switch device 800b may be transmitted via multiple lanes in the switch device 800b. The multiple lanes may facilitate the in-band traffic 820 and/or the out-of-band traffic 825.

The multiple lanes between the multiple first electronic devices 805 and the multiple second electronic devices 810 may be in an any-to-any configuration. For example, the first DSP device 805a may include a lane to the first analog IC 810a, to the second analog IC 810b, and/or the mth analog IC 810c. A similar arrangement may occur for each of the multiple first electronic devices 805, such that each DSP device of the multiple first electronic devices 805 may include a lane to any number of the multiple second electronic devices 810, including none of the multiple second electronic devices 810. Each lane for facilitating the in-band traffic 820 may be in both directions (e.g., transmit and receive) between the multiple first electronic devices 805, the multiple second electronic devices 810, and/or a device 830. Alternatively, or additionally, the lanes are dashed/dotted to illustrate that for any transmit/receive path between the multiple first electronic devices 805, the multiple second electronic devices 810, and/or a device 830, a lane may or may not be present.

The multiple first electronic devices 805, the multiple second electronic devices 810, and/or the switch controller 815 may be disposed on a printed circuit board (PCB) where traces on the PCB may be used to connect at least the multiple first electronic devices 805, the multiple second electronic devices 810, and/or the switch controller 815 (e.g., the traces on the PCB may facilitate the in-band traffic 820 and/or the out-of-band traffic 825 in the switch device 800b). Alternatively, or additionally, the multiple first electronic devices 805, the multiple second electronic devices 810, and/or the switch controller 815 may be connected to one another using connectors, such as high-speed cables, where the multiple first electronic devices 805, the multiple second electronic devices 810, and/or the switch controller 815 may individually include ports/headers to support the use of the connectors. In instances in which the connectors are used, crosstalk between the multiple lanes in the switch device 800b may be reduced relative to the crosstalk that may occur when the switch device 800b uses traces on a PCB.

The switch device 800b, including the multiple first electronic devices 805, the multiple second electronic devices 810, and/or the switch controller 815, may be utilized with one or more additional switches and/or crossbar devices to form a new crossbar switch device, which may be larger than any one of the switch devices 800b. For example, as illustrated and discussed relative to FIG. 8C, the switch device 800b may be utilized with any other number of switch devices 800b (e.g., the nth switch device 800ac in FIG. 8C) and multiple analog crossbar switches 840 to form a new crossbar switch device.

The multiple first electronic devices 805 may be digital signal processors (DSPs) and/or the multiple second electronic devices 810 may be analog circuit switch integrated circuits (ICs) for use with electrical signals. Alternatively, or additionally the multiple second electronic devices 810 may be analog optical circuit switch ICs for use with optical signals. The multiple first electronic devices 805 may be individually configured to support one or more layer of the open systems interconnection (OSI) model. For example, each of the multiple first electronic devices 805 may be configured to support layer 1 protocols, layer 2 protocols, and/or layer 3 protocols with respect to the in-band traffic 820 and/or the out-of-band traffic 825.

Each, or at least one, of the multiple first electronic devices 805 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 805 may be able to adjust the way in which traffic is directed through it, such as in response to a command from the switch controller 815. For example, each of the multiple first electronic devices 805 may be operable to configure an internal switch, an external switch, or a crossbar based on the various layer protocol processing to be performed.

The first DSP device 805a may receive a communication that includes a frame header (or a packet header) and the first DSP device 805a may be configured to detect the frame header and decode the frame header along with any associated contents of the communication, all within the first DSP device 805a. In a second example, the first DSP device 805a may integrate a media access control (MAC) address lookup table which may allow the first DSP device 805a to configure one or more crossbars such that the first DSP device 805a may facilitate connectivity between any two MAC addresses that are included in the lookup table. Alternatively, or additionally, each of the first electronic devices 805 may include a lookup table that may store equalization settings that may be used for various connections between the first electronic devices 805 and other components within the switch device 800b. The equalization settings in the lookup table may be used to accelerate acquisition and/or tracking for a particular DSP device of the multiple first electronic devices 805 when the particular DSP device switches connections within the switch device 800b.

The multiple first electronic devices 805 may be configured to respond to layer 2 protocol requests and/or layer 3 protocol requests for connectivity and/or resource grant requests. For example, the multiple first electronic devices 805 may compare a request to a lookup table that includes priority levels and the multiple first electronic devices 805 may be operable to configure themselves and/or associated crossbars and/or switches based on the determined priority level. Alternatively, or additionally, each of the multiple first electronic devices 805 may be configured to respond to in-band requests (e.g., granting a connection request, signaling backpressure to the device 830, etc.), collect statistics on traffic handled by the multiple first electronic devices 805 (e.g., link utilization and/or traffic type), and/or perform data filtering (e.g., detecting a particular header, performing routing, generating flags and/or interrupts, and/or logging any of the filtering events).

The multiple first electronic devices 805 may be configured to communicate with (e.g., transmit data to and/or receive data from) the device 830. The communication with the device 830 may include in-band traffic 820. In such instances, the communications between the multiple first electronic devices 805 and the device 830 may be line-side communications, where the lines may facilitate communications using various communication channels. For example, the line-side communications between the multiple first electronic devices 805 and the device 830 may be an electrical-to-electrical connection, an optical-to-optical connection, an electrical-to-optical connection, or an optical-to-electrical connection, and so forth.

The device 830 may address communications directly to one of the multiple first electronic devices 805. For example, the device 830 may address communications to the second DSP device 805b. Alternatively, or additionally, the device 830 may address communications to the switch controller 815, which may then direct communications to the appropriate DSP device. For example, the device 830 may address communications intended for the second DSP device 805b to the switch controller 815 and the switch controller 815 may direct the communications to the second DSP device 805b.

The multiple first electronic devices 805 may individually include memory that may be used as a buffer for communications through the multiple first electronic devices 805. The memory in the multiple first electronic devices 805 may be utilized to buffer incoming and/or outgoing traffic, which may include in-band traffic 820 and/or out-of-band traffic 825. Due to the memory in the multiple first electronic devices 805 being distributed (e.g., by the distributed nature of the multiple first electronic devices 805), the switch device 800b may not include any memory for buffering in addition to the memory included in the multiple first electronic devices 805.

The multiple first electronic devices 805 may individually include one or more additional lanes that may be used for communications in the switch device 800b. Further details associated with the additional lanes are included in the description associated with FIG. 8C.

The multiple second electronic devices 810 may individually include one or more ports that may be used to facilitate communications within the switch device 800b, similar to the ports described relative to the multiple first electronic devices 805. Alternatively, or additionally, the lanes for communications between the multiple first electronic devices 805 and the multiple second electronic devices 810 may be coupled with the ports included in the multiple second electronic devices 810.

The switch controller 815 may be a microcontroller unit (MCU). Alternatively, or additionally, the switch controller 815 may be a DSP, or other processing device. The switch controller 815 may be communicatively coupled with at least the multiple first electronic devices 805 and/or the multiple second electronic devices 810. The switch controller 815 may resolve resource grant requests, distribute the network state to the multiple first electronic devices 805 and/or to the multiple second electronic device 810, and/or may establish and/or maintain timing among the components included in the switch device 800b.

The switch controller 815 may communicate with the multiple first electronic devices 805 and/or the multiple second electronic devices 810 using a separate connection/lane than the connections between the multiple first electronic devices 805 and the multiple second electronic devices 810. For example, the first connection between the multiple first electronic devices 805 and the multiple second electronic devices 810 may facilitate the in-band traffic 820 and the second connection between the switch controller 815 and the multiple first electronic devices 805 and/or the multiple second electronic devices 810 may facilitate the out-of-band traffic 825.

The out-of-band traffic 825 may use a different network than the in-band traffic 820. Alternatively, or additionally, the out-of-band traffic 825 may use a different physical layer protocol than the in-band traffic 820. The out-of-band traffic 825 may be used to manage and/or configure one or more components included in the switch device 800b. For example, the switch controller 815 may communicate with the multiple first electronic devices 805 using the out-of-band traffic 825 to reconfigure lanes and/or traffic routing based on the traffic through the switch device 800b.

The switch controller 815 may be programmable such that the switch controller 815 may be operable to dynamically map the lanes between the multiple first electronic devices 805 and the multiple second electronic devices 810. For example, in instances in which the first DSP device 805a includes a lane to the first analog IC 810a, the switch controller 815 may dynamically map the lane to be from the first DSP device 805a to the second analog IC 810b. The switch controller 815 may dynamically adapt the mapping of the lanes between the multiple first electronic devices 805 and the multiple second electronic devices 810 based on one or more conditions and/or a satisfaction of a threshold related to the conditions. For example, in instances in which the real-time data traffic in the switch device 800b (or an amount of real-time data traffic handled by one of the multiple first electronic devices 805 and/or one of the multiple second electronic devices 810) satisfies a threshold, the switch controller 815 may dynamically adapt the mapping of the lanes as described.

The switch device 800b may include one or more redundant lanes that may be used in various situations during operation of the switch device 800b. For example, one or more redundant lanes may be used for the out-of-band traffic 825, such as signaling using the out-of-band traffic 825. In such instances, the out-of-band signaling may be transmitted and/or received by a particular DSP device and/or by the switch controller 815, and the out-of-band signaling may be a lower transmission rate than the in-band traffic 820. In another example, one or more redundant lanes may be used for out-of-bandwidth broadcasts from the switch controller 815 and/or from one or more of the multiple first electronic devices 805 to other devices in the switch device 800b (e.g., such as other DSP devices).

The switch controller 815 may reserve a portion of bandwidth associated with the in-band traffic 820 in the switch device 800b. The bandwidth reserved by the switch controller 815 may be reserved on a per lane basis of the multiple lanes included in the switch device 800b. For example, a first lane between the first DSP device 805a and the first analog IC 810a may have a first reserved bandwidth and a second lane between the second DSP device 805b and the second analog IC 810b may have a second reserved bandwidth, where the amount of bandwidth reserved may be the same or may differ between the first reserved bandwidth and the second reserved bandwidth. The switch controller 815 may allocate resources within the switch device 800b based on predicted or anticipated traffic (e.g., based on a probabilistic model).

Alternatively, or additionally, the switch controller 815 may monitor the lanes of the multiple lanes in the switch device 800b. The switch controller 815 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 815 may dynamically remap a new lane in the switch device 800b to replace the degraded lane.

The switch controller 815 may perform adaptive signal equalization to the in-band traffic 820 in the switch device 800b. For example, the multiple first electronic devices 805 may provide feedback to the switch controller 815 relative to the workload handled by the multiple first electronic devices 805, and the switch controller 815 may adaptively manage workloads of the multiple first electronic devices 805 to optimize performance of the switch device 800b.

A backup switch controller (not illustrated) may be included in the switch device 800b. The backup switch controller may be a redundant controller relative to the switch controller 815. The backup switch controller may include the same or similar connections as the switch controller 815 relative to the multiple first electronic devices 805 and/or the multiple second electronic devices 810. The backup switch controller may perform the same or similar operations as the switch controller 815.

FIG. 8C illustrates an example switch device 800c. The switch device 800c may include a first DSP device 805a, an nth DSP device 805c, and multiple analog ICs 835. The first DSP device 805a may include a first auxiliary channel 807a, and a first out-of-band channel 809a. The nth DSP device 805c may include an nth auxiliary channel 807c, and an nth out-of-band channel 809c.

The first DSP device 805a, the nth DSP device 805c, and the multiple analog ICs 835 may be the same or similar as the first DSP device 805a, the nth DSP device 805c, and the multiple second electronic devices 810, respectively, of FIG. 8A and may be operable to perform the same or similar functions as described.

The auxiliary channels 807 (e.g., the first auxiliary channel 807a and the second auxiliary channel 807c) may be individually utilized by each of the DSP devices 805a, 805c as an additional lane for in-band traffic between at least the DSP devices 805a, 805c and the multiple analog ICs 835. The auxiliary channels 807 may be used to redundantly transmit in-band traffic relative to another lane included in the DSP devices 805a, 805c prior to a change in configuration to the corresponding DSP devices 805a, 805c. For example, in instances in which the first DSP device 805a includes a lane to a particular analog IC of the multiple analog ICs 835 and the first DSP device 805a is to be reconfigured (e.g., by a switch controller as described herein), the first auxiliary channel 807a may have a lane mapped to the particular analog IC such that the in-band traffic is redundant between the first DSP device 805a and the particular analog IC prior to reconfiguring the lanes associated with the first DSP device 805a (which reconfiguration may otherwise break the connection between the first DSP device 805a and the particular analog IC).

The auxiliary channels 807 may be used for communication between other near DSP devices. For example, in instances in which the first DSP device 805a is disposed spatially near to the nth DSP device 805c, the first DSP device 805a and the nth DSP device 805c may communicate with one another via the auxiliary channels 807. Such communications may be possible as the channels between near-neighbors may be relatively clean, such that physical layer processing may be simplified and may result in power reduction, latency reduction, a lesser amount of equalization, and/or other benefits to the switch device 800c.

The out-of-band channels 809 may be used to communicate the out-of-band traffic (e.g., the out-of-band traffic 825 of FIG. 8B) on a lane separate from the multiple lanes used to communicate in-band traffic. In such instances, the out-of-band channels 809 may not cause blocking or interference to the in-band traffic between at least the DSP devices 805a, 805c and the multiple analog ICs 835.

FIG. 8D illustrates an example aggregated switch device 800d. The aggregated switch device 800d may include a first switch device 800aa, an nth switch device 800ac, and multiple analog crossbar switches 840. The first switch device 800aa and the nth switch device 800ac may individually be the same or similar as the switch device 800b of FIG. 8B.

The aggregated switch device 800d illustrates that any number of the switch devices 800b (e.g., the first switch device 800aa and the nth switch device 800ac) may be aggregated into another switch device and/or connected to other analog crossbar switches. Each of the switch devices 800b may include multiple DSP devices and multiple analog IC and may be further aggregated into the aggregated switch device 800d using the multiple analog crossbar switches 840. As such, the aggregated switch device 800d may be scaled up or down for any size communication need, by adjusting the switch devices 800b and/or the multiple analog crossbar switches 840 to meet the communication demand.

### EXAMPLES

In some examples, a method may include establishing a reconfigured primary communication channel between the first device and the second device. In some examples, a method may include transitioning traffic from the auxiliary communication channel to the reconfigured primary communication channel upon successful establishment of the reconfigured primary communication channel. In some examples, a method may include deactivating the auxiliary communication channel to conserve resources after the transition. In some examples, the auxiliary communication channel may be configured to operate as an out-of-band channel during steady-state operation and may be dynamically activated to enable seamless transitions in response to network events, and in which the transitioning of traffic may be performed without disrupting ongoing data flow or introducing significant latency in the communication system.

A communication system may include a controller that may: reconfigure the primary communication channel by routing traffic through analog crossbars; transition data traffic back to the reconfigured primary communication channel; and/or deactivate the auxiliary communication channel to conserve resources after the transition is complete. The communication system may include a non-volatile memory operatively coupled to the controller, the non-volatile memory configured to store crossbar configurations and recover the system state after power interruptions. The auxiliary communication channel may operate as an out-of-band channel during steady-state operation and dynamically support in-band traffic during MBB transitions to ensure uninterrupted data flow and minimal latency.

In some examples, a method may include establishing, by a controller, an auxiliary communication channel between a first device and a second device in a network, in which the auxiliary communication channel is distinct from a primary communication channel used for transmitting operational data. In some examples, a method may include configuring the auxiliary communication channel to support data transmission by routing traffic through the auxiliary communication channel while maintaining connectivity of the primary communication channel. In some examples, a methods may include transitioning, by the controller, traffic from the primary communication channel to the auxiliary communication channel during a reconfiguration event.

In some examples, the auxiliary communication channel may be implemented using redundant communication paths within the network. In some examples, the reconfiguration event may include a failure in the primary communication channel, using failover to a redundant path. In some examples, the auxiliary communication channel may operate at a lower bandwidth or power consumption state during steady-state operation and transition to a high-performance state during reconfiguration events. In some examples, the method may include monitoring, by the controller, integrity of the primary communication channel and dynamically activating the auxiliary communication channel upon detection of degradation or failure. In some examples, the auxiliary communication channel may be used to communicate with nearest neighbor devices during steady-state operation to reduce latency and enable efficient reconfiguration. In some examples, the auxiliary communication channel may be used for transmitting out-of-band control signals to coordinate reconfiguration across multiple network nodes. In some examples, transitioning traffic may include buffering data to ensure that no data is lost during a reconfiguration process. In some examples, the auxiliary communication channel may be used to facilitate make-before-break operations in safety-critical applications, including autonomous vehicles, avionics systems, and industrial automation networks. In some examples, the controller may use time-division multiplexing to allocate bandwidth dynamically across auxiliary and primary communication channels to optimize resource utilization.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A method for transitioning network connections in a communication system, the method comprising:
establishing, by a controller, an auxiliary communication channel between a first device and a second device in a network, wherein the auxiliary communication channel is distinct from a primary communication channel used for transmitting operational data;
configuring the auxiliary communication channel to support data transmission by routing traffic through the auxiliary communication channel while maintaining connectivity of the primary communication channel; and
transitioning, by the controller, traffic from the primary communication channel to the auxiliary communication channel during a reconfiguration event.

2. The method of claim 1, wherein the auxiliary communication channel is implemented using redundant communication paths within the network.

3. The method of claim 1, wherein the reconfiguration event comprises a failure in the primary communication channel, requiring failover to a redundant path.

4. The method of claim 1, wherein the auxiliary communication channel operates at a lower bandwidth or power consumption state during steady-state operation and transitions to a high-performance state during reconfiguration events.

5. The method of claim 1, further comprising monitoring, by the controller, integrity of the primary communication channel and dynamically activating the auxiliary communication channel upon detection of degradation or failure.

6. The method of claim 1, wherein the auxiliary communication channel is used to communicate with nearest neighbor devices during steady-state operation to reduce latency and enable efficient reconfiguration.

7. The method of claim 1, wherein the auxiliary communication channel is used for transmitting out-of-band control signals to coordinate reconfiguration across multiple network nodes.

8. The method of claim 1, wherein transitioning traffic includes buffering data to ensure that no data is lost during a reconfiguration process.

9. The method of claim 1, wherein the auxiliary communication channel is used to facilitate make-before-break operations in safety-critical applications, including autonomous vehicles, avionics systems, and industrial automation networks.

10. The method of claim 1, wherein the controller uses time-division multiplexing to allocate bandwidth dynamically across auxiliary and primary communication channels to optimize resource utilization.

11. A communication system configured for seamless network reconfiguration using make-before-break (MBB) protocols, the system comprising:
a plurality of physical media-dependent (PMD) devices, each including:
a primary transceiver configured to transmit and receive operational data over a primary communication channel, and
an auxiliary transceiver configured to establish an auxiliary communication channel for facilitating traffic transitions during network reconfiguration;
a plurality of analog crossbars operatively coupled to the PMD devices, the analog crossbars configured to facilitate switching of communication paths for in-band traffic;
a plurality of redundant analog crossbars coupled to the PMD devices and the analog crossbars, the redundant analog crossbars configured to support auxiliary communication channels and provide failover paths; and
a controller configured to:
dynamically activate the auxiliary transceivers and establish auxiliary communication channels in response to a reconfiguration event, and
transition data traffic from the primary communication channel to the auxiliary communication channel.

12. The system of claim 11, wherein the auxiliary transceiver operates at a lower power state during steady-state operation and transitions to a high-power state during reconfiguration events.

13. The system of claim 11, wherein the redundant analog crossbars are configured to facilitate hitless switching by providing alternative paths for data transmission during reconfiguration.

14. The system of claim 11, wherein the controller is configured to monitor integrity of the primary communication channels and activate auxiliary communication channels upon detecting signal degradation or failure.

15. The system of claim 11, wherein the auxiliary communication channels are configured to support time-division multiplexing for dynamic bandwidth allocation during reconfiguration events.

16. The system of claim 11, wherein the auxiliary communication channels are used for nearest neighbor communication during steady-state operation to reduce latency and optimize system performance.

17. The system of claim 11, wherein the controller is configured to buffer data during transitioning traffic from the auxiliary communication channel to reconfigured primary communication channel to prevent data loss.

18. The system of claim 11, wherein redundant analog crossbars support both in-band traffic and out-of-band signaling to enable coordination across multiple PMD devices.

19. The system of claim 11, wherein the system is implemented in a data center environment to support scalable, high-performance network operations.

20. The system of claim 11, wherein the auxiliary communication channels and MBB protocols are applied to safety-critical systems, including autonomous vehicles and aerospace networks, to ensure uninterrupted operation during reconfiguration events.
